(19) United States
(12) Patent Application Publication
(10) Pub. No.: US 2012/0275959 A1
(43) Pub. Date: Nov. 1, 2012

(54) APPARATUS FOR PERFORMING HAEMOSTASIS TESTS

(75) Inventors: Frank Gehring, Obernheim (DE); Lothar Mueller, Wiesbaden (DE)

(73) Assignee: ANDREAS HETTICH GMBH & CO. KG, TUTTLINGEN (DE)

(21) Appl. No.: 13/394,336

(22) PCT Filed: Sep. 9, 2009
(86) PCT No.: PCT/EP2010/005534

§ 371 Date: Jul. 6, 2012

(30) Foreign Application Priority Data
Sep. 9, 2009 (DE) 10 2009 040 880.0

(51) Int. Cl. G01N 21/55

(52) U.S. Cl. 422/73

(57) ABSTRACT

The invention relates to a device for measuring coagulation parameters in a sample fluid, comprising an interface sensor with a sensor surface that faces the sample fluid. The invention is characterized in that said sensor surface includes adhesive areas and non-adhesive areas with respect to blood components.

This application is the national phase entry of PCT/EP2010/005534. This application claims the benefit and priority of and to PCT/EP2010/005534, international application filing date Sep. 9, 2010, which claims the benefit and priority of and to German patent application no. DE 10 2009 040 880.0, filed Sep. 9, 2009. Further, PCT/EP2010/005534 and German patent application no. DE 10 2009 040 880.0 are hereby incorporated herein by reference hereto.

The analysis of blood is of vital importance in medicine. It allows the detection of various diseases, anomalies, infections or coagulation disorders. Such analyses are generally performed on samples which were first taken from a blood stream and then further processed in a laboratory. Haemostasis analysis plays a special part here. Devices are already widely used which allow a patient to directly determine a certain coagulation value. This is mainly true for Quick's value, the prothrombin time. However, for analysing different parameters, separate devices have so far been required.

Furthermore, devices have been known that determine a substance characteristic by means of a vibrating quartz crystal. This technology is widely known as “Quartz Crystal Microbalance” (QCM), as disclosed for example in DE 696 101 83 T2. One aspect of QCM is based on the fact that the desired substances will adsorb to the specifically adhesive surface of the quartz crystal, thus changing its resonance frequency which in turn allows a conclusion to be drawn regarding the number or the functionality of the substances. Furthermore, quartz crystals have been disclosed in WO 99 403 97 which comprise several oscillators and exhibit different coatings for the detection of different substances.

Coagulation measurement using a resonator or a vibrating quartz crystal according to the prior art is rather inaccurate. For example, a viscosity measurement will not be possible if a viscoelastic layer is formed on a surface which has acoustically impermeable properties. This is the case, for example, if this layer is too thick for the penetration depth of the acoustic wave, thus preventing the acoustic wave from reaching the sample fluid to be measured.

On the other hand, there is the additional problem that in a completely protein- and/or cell-resistant surface, coagulation will not directly take place on the vibrating quartz crystal surface. As a result, the acoustic waves will not be able to penetrate deeply enough into the medium to be measured. In this case, the viscosity change brought about by coagulation cannot be measured at all or will not yield valid measurements. Thus, while it is generally known to measure blood parameters using a vibrating quartz crystal or a thickness-shear vibrator with a surface that faces the blood sample, the results obtained may not necessarily be reproducible, however.

It is the object of the invention to provide an apparatus for measuring haemostasis which allows a reliable, precise and fast determination of various primary and secondary haemostasis parameters.

The apparatus according to the invention for measuring haemostasis parameters comprises an interface sensor having a sensor surface which consists of both adhesive and non-adhesive areas with respect to blood components.

The combination of adhesive and non-adhesive areas of the resonator surface has the advantage that blood components of a sample fluid will merely bind to the adhesive areas and bridge the non-adhesive areas by forming aggregates and fibrin meshes.

This reliably ensures that coagulation will take place directly on the sensor surface and that the viscosity change in the acoustically impermeable protein- and/or cell-resistant areas brought about by coagulation will result in a useful sensor signal. Moreover, this ensures reliable and precise measurement of haemostasis parameters. In addition, the fact that the blood components can only bind to certain areas will ensure that the thicknesses of the layers created on the sensor surface will be smaller than the penetration depth of the interface sensor.

For the sake of brevity, we will refrain from describing the excitation by an oscillator module and the specific type of vibration measurement used here. Vibrational excitation and measurement are known prior art and do not contribute to the concept of the present invention but merely provide the framework conditions.

In yet another advantageous embodiment, the non-adhesive areas are made to be protein- and/or cell-resistant. This has the advantage that blood components will not adsorb to these surface areas. When there is an excessive amount of blood components adhering to the surface, valid measurement of a viscosity change will no longer be possible since the viscosity will be masked by the adhesion and/or the layer will be acoustically impermeable.

In yet another particularly advantageous embodiment, the adhesive and non-adhesive areas are arranged in the shape of a mosaic on the surface of the vibrating quartz crystal. Such a surface design allows particularly precise measurements to be performed. Such a subdivision into different areas ensures optimal distribution of the anchoring sites which promotes the formation of a largely homogeneous layer.

In particular, the adhesive areas are made of gold and the non-adhesive areas are made of poly ethylene (PE). Using these materials for the surface areas is advantageous in that both gold and poly ethylene (PE) are widely used in microsystems engineering and thus well known and easy to process. Another advantage of the use of a gold layer is that it may simultaneously serve as an electrode of the vibrating quartz crystal.

In particular, the surface of the vibrating quartz crystal is subdivided such that the non-adhesive areas occupy between at least 20 per cent and maximally 90 per cent of the total sensor surface. This range will yield the best results.

Preferably, an activator such as thrombin has already been incorporated into the sensor surface. This avoids the problem of having to keep the time period from sample activation to the actual measurement especially short. For this reason, the entire apparatus can be of a simpler design. The activator may be applied both to the adhesive areas and the non-adhesive areas.

The blood components will become activated as they adhere to the fibrinogen layer, which will then trigger aggregation. This will allow the determination of the coagulation time, for example, from the time when the blood was applied until the actual coagulation.

In a particularly advantageous embodiment, the interface sensor is provided in the form of an acoustic resonator. Alternatively, the resonator may take the form of a thickness-shear vibrator, a quartz crystal microbalance or a vibrating quartz crystal. These forms are widely used and well known in analytics.

According to an advantageous further development, the resonator surface may also include multiple layers. This is above all advisable for more complex coating processes.

In yet another embodiment, the interface sensor takes the form of an optical sensor, in particular for surface plasmon resonance measurement.

Further advantages, features and possible applications of the present invention will become obvious from the description which follows, in combination with the embodiment illustrated in the drawings. The invention will now be described in more detail with reference to the single drawing. Throughout the description, the claims, the abstract and the drawing, those terms and reference numerals will be used as are listed in the list of reference numerals below. The sole FIGURE of the drawing,

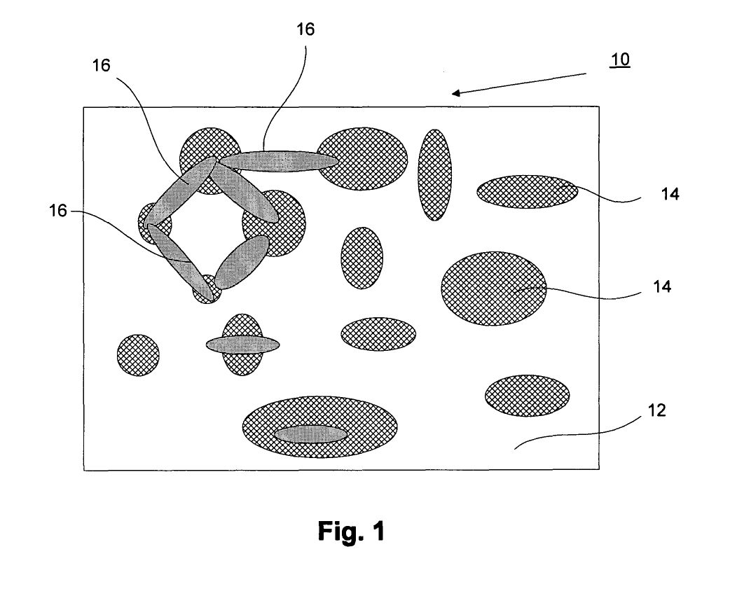

FIG. 1 is an illustration of a vibrating quartz crystal surface consisting of PE and gold.

FIG. 1 shows the surface of a vibrating quartz crystal 10 which exhibits a PE layer 12 and a gold layer 14. In a known manner, the PE layer has been made to be cell-resistant. It thus prevents the adsorption of proteins and other cell components and blood components 16. The gold layer 14 by contrast is adhesive and thus allows blood components adsorption in this area. The blood components bridge the non-adhesive PE areas. The fact that only a small number of adsorption sites exist will ensure a thickness of the blood components layer which allows sufficiently deep acoustic penetration. Furthermore, as a result of the anchoring sites formed, the coagulation process will be triggered near the surface of the vibrating quartz crystal.

Thus it will not be only possible to measure plasmatic coagulation parameters but to also determine platelet function. As a result, it can be determined which coagulation branch is defective.

### LIST OF REFERENCE SIGNS

10 vibrating quartz crystal

12 PE layer

14 gold layer

16 blood components

1-12. (canceled)

13. An apparatus for measuring coagulation parameters in a sample fluid, comprising:
an interface sensor (10), said interface sensor includes a sensor surface, said sensor surface faces said sample fluid;
said sample fluid includes blood components;
said sensor surface includes adhesive areas (14), said adhesive areas are adhesive with respect to blood components; and,
said sensor surface includes non-adhesive areas (12), said non-adhesive areas are non-adhesive with respect to blood components.

14. The apparatus of claim 13 characterized in that said non-adhesive areas (12) of said sensor surface are made to be as protein resistant and/or cell resistant as possible.

15. The apparatus of claim 13 characterized in that said adhesive areas (14) of said sensor surface and said non-adhesive areas (12) of said sensor surface are arranged in a mosaic on said sensor surface.

16. The apparatus of claim 13 characterized in that said non-adhesive areas of said sensor surface are made of polymer coatings, in particular polyethylene or polyethylene glycol.

17. The apparatus of claim 13 characterized in that said adhesive areas (14) of said sensor surface are made of gold or polystyrene.

18. The apparatus of claim 13 characterized in that said non-adhesive areas of said sensor surface occupy between at least 20% and maximally 90% of the total surface.

19. The apparatus of claim 13 characterized in that one activator has been incorporated into said sensor surface.

20. The apparatus of claim 19 characterized in that said sensor surface includes fibrinogen.

21. The apparatus of claim 20 characterized in that said sensor surface includes multiple layers.

22. The apparatus of claim 13 characterized in that said interface sensor is provided in the form of a resonator.

23. The apparatus of claim 22 characterized in that said resonator is in the form of an acoustic resonator, in particular in the form of a vibrating quartz crystal or a thickness-shear vibrator.

24. The apparatus of claim 13 characterized in that said interface sensor is provided in the form of an optical sensor, in particular for surface plasmon resonance measurement.

25. The apparatus of claim 14 characterized in that said interface sensor is provided in the form of a resonator.

26. The apparatus of claim 15 characterized in that said interface sensor is provided in the form of a resonator.

27. The apparatus of claim 16 characterized in that said interface sensor is provided in the form of a resonator.

28. The apparatus of claim 25 characterized in that said resonator is in the form of an acoustic resonator, in particular in the form of a vibrating quartz crystal or a thickness-shear vibrator.

29. The apparatus of claim 26 characterized in that said resonator is in the form of an acoustic resonator, in particular in the form of a vibrating quartz crystal or a thickness-shear vibrator.

30. The apparatus of claim 27 characterized in that said resonator is in the form of an acoustic resonator, in particular in the form of a vibrating quartz crystal or a thickness-shear vibrator.

31. The apparatus of claim 14 characterized in that said interface sensor is provided in the form of an optical sensor, in particular for surface plasmon resonance measurement.

32. The apparatus of claim 15 characterized in that said interface sensor is provided in the form of an optical sensor, in particular for surface plasmon resonance measurement.
